(19) United States
(12) Patent Application Publication
(10) Pub. No.: US 2016/0195130 A1
(43) Pub. Date: Jul. 7, 2016

(54) BEARING ASSEMBLY WITH INTEGRATED VIBRATION DAMPING

(71) Applicant: Schaeffler Technologies AG & Co. KG, Herzogenaurach (DE)

(72) Inventor: William Moratz, Gardiner, NY (US)

(73) Assignee: SCHAEFFLER TECHNOLOGIES AG & CO. KG, Herzogenaurach (DE)

(21) Appl. No.: 14/591,376

(22) Filed: Jan. 7, 2015

(51) Int. Cl. F16C 19/52; F16C 43/04

(52) U.S. Cl. CPC F16C 19/527; F16C 43/04

(57) ABSTRACT

A bearing assembly, including a housing with a radially inner circumferential surface; a bearing including an outer ring with a first circumferentially disposed groove; and, a vibration damping ring disposed within the first circumferentially disposed groove, contacting the housing at the radially inner circumferential surface and the vibration damping ring damps vibration transfer between the housing and the outer ring. A method of damping vibration transfer between a housing and a bearing outer ring using vibration damping rings.

### TECHNICAL FIELD

The present disclosure relates to a bearing assembly including a vibration damping feature disposed in respective grooves in an outer ring of the bearing, in particular for floating bearing fit assemblies in machinery.

### BACKGROUND

Bearing assemblies, for example for machinery, such as electric motors, gearboxes, high speed spindles, and turbines, are known to include a housing made of a first material and an outer race radially enclosed by the housing and made of a second material. The first material and the second material may also be the same material, for example steel or the two materials may be substantially similar materials such as bearing steel (bearing) and another ferrous metal (housing). In a typical shaft installation, there may be a fixed or press fit bearing to locate the assembly and a floating or loose fit bearing to allow for thermal expansion or contraction. In some other assemblies both bearings may be floating or loose fit, to allow for some axial displacement.

Damage due to passage of vibration from machines through rolling bearings is common. Vibration can eventually cause bearings or components thereof to fail. Vibration may also cause damage to other elements of the machine. A mechanism to dampen vibration from the housing to the shaft or inner ring of the bearing is needed, in particular a vibration damping feature integrated into the rolling element bearing that has a floating fit in a housing.

### SUMMARY

According to aspects illustrated herein, there is provided a bearing assembly, including: a housing with a radially inner circumferential surface; a bearing including an outer ring with a first circumferentially disposed groove; and, a vibration damping ring disposed within the first circumferentially disposed groove, contacting the housing at the radially inner circumferential surface and the vibration damping ring damps vibration transfer between the housing and the outer ring.

According to aspects illustrated herein, there is provided a bearing assembly, including: a housing with a radially inner circumferential surface; a bearing including an outer ring with first and second circumferentially disposed grooves; and, two vibration damping rings disposed within the first and second circumferentially disposed grooves, contacting the housing at the radially inner circumferential surface and damping vibration transfer between the housing and the outer ring.

According to aspects illustrated herein, there is provided a method of damping vibration between a housing and a bearing, including: locating a first portion of an annular vibration damping ring within a first circumferentially disposed groove for an outer ring of the bearing; installing a housing radially about the outer ring such that the housing contacts the vibration damping ring and does not contact the outer ring; damping, with contact between vibration damping ring and the housing, vibration transfer between the housing and outer ring by creating compressive force between the vibration damping ring and the radially inner surface of the housing; and, creating a gap between the housing and the outer ring such that no direct compressive force is created between the radially inner surface of the housing and radially outer surface of the outer ring.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a perspective view of a cylindrical coordinate system demonstrating spatial terminology used in the present application;

FIG. 2 is a partial cross-sectional view of a bearing assembly with vibration damping rings according to an example embodiment;

FIG. 3 is a partial cross-sectional view of a bearing assembly with a vibration damping ring according to a second example embodiment.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

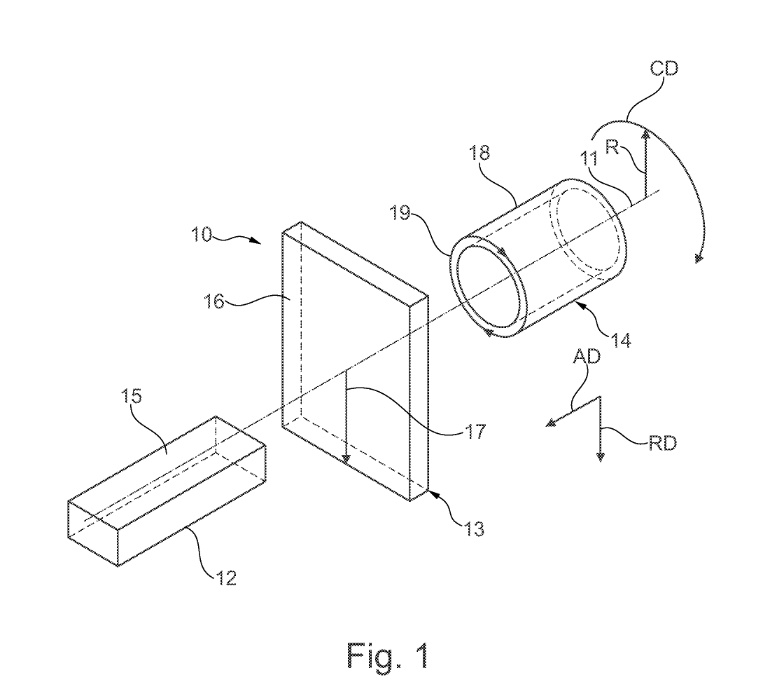

FIG. 1 is a perspective view of cylindrical coordinate system 10 demonstrating spatial terminology used in the present application. The present application is at least partially described within the context of a cylindrical coordinate system. System 10 includes longitudinal axis 11, used as the reference for the directional and spatial terms that follow. Axial direction AD is parallel to axis 11. Radial direction RD is orthogonal to axis 11. Circumferential direction CD is defined by an endpoint of radius R (orthogonal to axis 11) rotated about axis 11.

To clarify the spatial terminology, objects 12, 13, and 14 are used. An axial surface, such as surface 15 of object 12, is formed by a plane co-planar with axis 11. Axis 11 passes through planar surface 15; however any planar surface co-planar with axis 11 is an axial surface. A radial surface, such as surface 16 of object 13, is formed by a plane orthogonal to axis 11 and co-planar with a radius, for example, radius 17. Radius 17 passes through planar surface 16; however any planar surface co-planar with radius 17 is a radial surface. Surface 18 of object 14 forms a circumferential, or cylindrical, surface. For example, circumference 19 passes through surface 18. As a further example, axial movement is parallel to axis 11, radial movement is orthogonal to axis 11, and circumferential movement is parallel to circumference 19. Rotational movement is with respect to axis 11. The adverbs “axially,” “radially,” and “circumferentially” refer to orientations parallel to axis 11, radius 17, and circumference 19, respectively. For example, an axially disposed surface or edge extends in direction AD, a radially disposed surface or edge extends in direction R, and a circumferentially disposed surface or edge extends in direction CD.

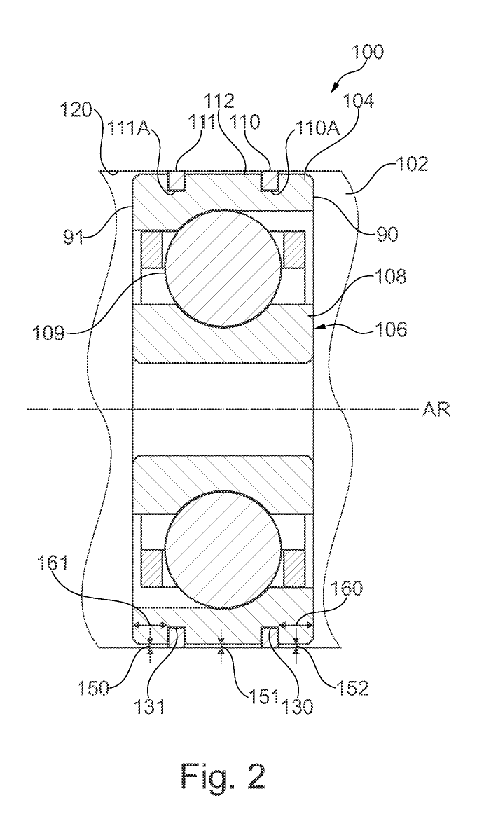

FIG. 2 is a partial cross-sectional view of bearing assembly 100 with vibration damping rings 110, 111. Assembly 100 includes axis AR, annular housing 102, annular outer ring 104 of bearing 106 and annular vibration damping rings 110, 111. Bearing 106 further includes rolling elements 109 between inner ring 108 and outer ring 104. Housing 102 includes radially inner circumferential surface 120. Outer ring 104 includes radially outer circumferential surface 112 with two circumferentially disposed grooves 130, 131 spaced apart and towards but not contacting opposite axial ends 90, 91 of outer ring 104. That is, grooves 130, 131 intersect surface 112. Rings 110 and 111 are disposed in grooves 130 and 131. For example, radially innermost portion 110A of ring 110 is disposed in groove 130 and radially innermost portion 111A of ring 111 is disposed in groove 131. Housing 102 is radially disposed about ring 104. Vibration damping rings 110 and 111 protrude radially above radially outer circumferential surface 112 of outer ring 104. By “circumferentially disposed” we mean that the respective groove extends continuously about the housing or race in the circumferential direction defined above and has a depth in the radial direction as defined above and a width in the axial direction as defined above. In an example embodiment, one or both of grooves 130 and 131 extend 360 degrees in the circumferential direction. In an example embodiment, one or both of grooves 130 and 131 extend less than 360 degrees in the circumferential direction. For example, circumferential ends of groove 130 are separated by a portion of surface 112. In addition, it should be understood that grooves 130 and 131 are axially located at opposite axial ends 90 and 91 of surface 112 of outer ring 104, but do not contact ends 90 and 91, such that there are axial gaps 160 and 161 formed between grooves 130 and 131 and ends 90 and 91.

In an example embodiment, vibration damping rings 110 and 111 are constructed of a damping material, meaning a material more compliant than the material comprising housing 102 and bearing outer ring 104, for example an elastomer. In an example embodiment, vibration damping rings 110 and 111 are tightly assembled in grooves 130 and 131. In an example embodiment, damping rings 110 and 111 are fixedly assembly in grooves 130 and 131, for example by gluing. Housing 102 is radially disposed about ring 104, but, does not contact ring 104, instead housing 102 contacts vibration damping rings 110 and 111, creating gaps 150, 151 and 152 between housing 102 and ring 104. Vibration is transferred from housing 102 through vibration damping rings 110, 111 and into bearing outer ring 104, by creating compressive force between vibration damping rings 110,111 and radially inner surface 120 of housing 102 and no direct compressive force between radially outer surface 112 of outer ring 104 and radially inner surface 120 of housing 102. Interference fit of the vibration damping rings 110 and 111 to housing 102 is at least 0.0002 mm to 0.0004 mm. Vibration or oscillation transfer is damped by vibration damping rings 110 and 111, such that vibration transfer to ring 104 is reduced or eliminated depending on the characteristics of the system, including, for example, how compliant the material of vibration damping rings 110 and 111 is, and the magnitude and frequency of the vibration in the system.

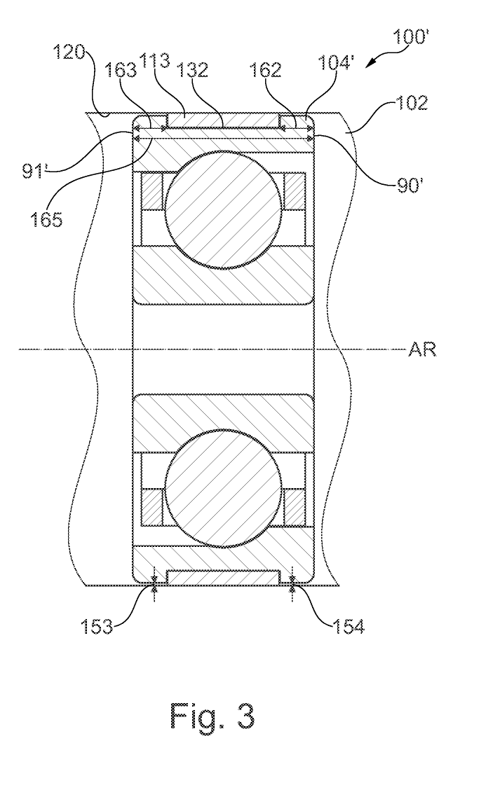

FIG. 3 is a partial cross-sectional view of bearing assembly 100′ with vibration damping ring 113. Assembly 100′ is similar to assembly 100 described above in the embodiment of FIG. 2, however, rings 110 and 111 are replaced by single vibration damping ring 113 that approaches up to half the width 165 of bearing outer ring 104′. Housing 102 is radially disposed about ring 104′, but, does not contact ring 104′, instead housing 102 contacts vibration damping ring 113, creating gaps 153 and 154 between housing 102 and ring 104′. Groove 132 does not contact ends 90′ and 91′, such that there are axial gaps 162 and 163 formed between axial ends of groove 132 and ends 90′ and 91′. Otherwise vibration damping ring 113 functions the same as described for vibration damping rings 110 and 111, namely, by damping vibration transfer between housing 102 and ring 104′, including the creation of gaps 153 and 154 between housing 102 and ring 104′.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

1. A bearing assembly, comprising:
a housing with a radially inner circumferential surface;
a bearing including an outer ring with a first circumferentially disposed groove; and,
a vibration damping ring disposed within the first circumferentially disposed groove, contacting the housing at the radially inner circumferential surface.

2. The bearing assembly of claim 1, wherein:
the outer ring includes a radially outer circumferential surface and the first circumferentially disposed groove intersects the radially outer circumferential surface.

3. The bearing assembly of claim 1, wherein:
the vibration damping ring damps vibration transfer between the housing and the outer ring.

4. The bearing assembly of claim 1, wherein:
the vibration damping ring is fixedly assembled within the first circumferentially disposed groove.

5. The bearing assembly of claim 1, wherein:
the vibration damping ring is made of an elastomer.

6. The bearing assembly of claim 1, wherein:
the bearing outer ring has a floating fit to the housing; and
the vibration damping ring has an interference fit to the housing.

7. The bearing assembly of claim 6, wherein:
the interference fit of the the vibration damping ring to the housing is at least 0.0002 mm to 0.0004 mm.

8. The bearing assembly of claim 2, wherein:
the vibration damping ring protrudes radially above the radially outer circumferential surface of the outer ring.

9. The bearing assembly of claim 1, wherein:
the bearing outer ring includes a second circumferentially disposed groove; and,
a second vibration damping ring disposed in the second circumferentially disposed groove.

10. A method of damping vibration between a housing and a bearing, comprising:
locating a first portion of an annular vibration damping ring within a first circumferentially disposed groove for an outer ring of the bearing;
installing a housing radially about the outer ring such that the housing contacts the vibration damping ring and does not contact the outer ring.

11. The method of claim 10, wherein:
damping, with contact between vibration damping ring and the housing, vibration transfer between the housing and outer ring by creating compressive force between the vibration damping ring and the radially inner surface of the housing; and radially inner and outer circumferential surfaces; and,
creating a gap between the housing and the outer ring such that no direct compressive force is created between the radially inner surface of the housing and radially outer surface of the outer ring.
